(19) United States
(12) Patent Application Publication
(10) Pub. No.: US 2015/0042597 A1
(43) Pub. Date: Feb. 12, 2015

(54) TOUCH DISPLAY DEVICE AND METHOD FOR SENSING CAPACITANCE THEREOF

(71) Applicant: Novatek Microelectronics Corp., Hsinchu (TW)

(72) Inventor: Shun-Li Wang, Hsinchu City (TW)

(73) Assignee: Novatek Microelectronics Corp., Hsinchu (TW)

(21) Appl. No.: 14/044,882

(22) Filed: Oct. 3, 2013

(30) Foreign Application Priority Data
Aug. 12, 2013 (TW) 102128853

(51) Int. Cl. G06F 3/044

(52) U.S. Cl. CPC G06F 3/044
USPC 345/174; 345/87

(57) ABSTRACT

A touch display device and a method for sensing capacitance thereof are provided. The touch display device includes a display panel having a plurality of liquid crystal pixels, a source driver, a touch panel having a plurality of touch areas, a touch sensing circuit and a crosstalk compensation unit. The source driver writes a plurality of pixel voltages into the liquid crystal pixels according to a plurality of display data. The touch panel is disposed and overlapped with the display panel. The touch sensing circuit senses a capacitance variation amount corresponding to each of the touch areas. The crosstalk compensation unit is coupled to the touch sensing circuit to receive the capacitance variation amount corresponding to each of the touch areas and corrects the capacitance variation amounts according to a plurality of capacitance crosstalk values corresponding to the liquid crystal pixels so as to provide a plurality sensing signals.

### CROSS-REFERENCE TO RELATED APPLICATION

This application claims the priority benefit of Taiwan application serial no. 102128853, filed on Aug. 12, 2013. The entirety of the above-mentioned patent application is hereby incorporated by reference herein and made a part of this specification.

### BACKGROUND

1. Field of the Invention

The present invention is directed to a display device and more particularly, to a touch display device.

2. Description of Related Art

Along with the rapid development and widespread applications of information technology, wireless mobile communication, and information appliances, the conventional input devices (such as keyboards and mice) of many information products have been gradually replaced by touch panels to achieve more convenience, more small volume, light weight and more user-friendly designs. Therein, a touch display panel with the touch control and display capabilities has become one of the most popular products nowadays.

At present, touch panels are generally categorized into resistive touch panels, capacitive touch panels, optical touch panels, acoustic wave touch panels, and electromagnetic touch panels, etc., and among them, the capacitive touch panels are commonly used products. When pixels of a display panel are liquid crystal pixels, liquid crystal capacitance of the liquid crystal pixels vary with received pixel voltages, which leads to affection on the capacitance sensed by the touch panel due to the occurrence of crosstalk, such that the determination of touch points of the touch panel are affected.

### SUMMARY

The present invention is directed to a touch display device and a method for sensing capacitance thereof, which are capable of eliminating the affection caused by the capacitance variation of liquid crystal of liquid crystal pixels to the capacitance of a touch panel.

The present invention is directed to a touch display device, including a display panel, a source driver, a touch panel, a touch sensing circuit and a crosstalk compensation unit. The display panel has a plurality of liquid crystal pixels. The source driver is coupled to the display panel and receives a plurality of display data and writes a plurality of pixel voltages to the liquid crystal pixels according to the display data. The touch panel is disposed and overlapped with the display panel and has a plurality of touch areas. Each of the touch areas respectively corresponds to a portion of the liquid crystal pixels. The touch sensing circuit is coupled to the touch panel and senses a capacitance variation amount of each of the touch areas. The crosstalk compensation unit is coupled to the touch sensing circuit, receives the capacitance variation amount of each of the touch areas, corrects the capacitance variation amount corresponding to each of the touch areas according to a plurality of capacitance crosstalk values respectively corresponding to the liquid crystal pixels and then, provides a plurality of sensing signals.

In an embodiment of the present invention, the crosstalk compensation unit corrects the capacitance variation amount corresponding to each of the touch areas according to the capacitance crosstalk values of the liquid crystal pixels corresponding to each of the touch areas and the capacitance crosstalk values of liquid crystal pixels neighboring with each of the touch areas.

In an embodiment of the present invention, the crosstalk compensation unit calculate a sum of the capacitance crosstalk values of the liquid crystal pixels corresponding to each of the touch areas respectively multiplied by a corresponding weighted value and the capacitance crosstalk values of the liquid crystal pixels neighboring with each of the touch areas respectively multiplied by a corresponding weighted value to obtain a reference capacitance crosstalk value and corrects the capacitance variation amount corresponding to each of the touch areas according to the reference capacitance crosstalk value.

In an embodiment of the present invention, the crosstalk compensation unit corrects the capacitance variation amount corresponding to each of the touch areas according to the capacitance crosstalk values of the liquid crystal pixels corresponding to each of the touch areas.

In an embodiment of the present invention, the crosstalk compensation unit calculates a sum of the capacitance crosstalk values of the liquid crystal pixels corresponding to each of the touch areas respectively multiplied by a corresponding weighted value to obtain a reference capacitance crosstalk value and corrects the capacitance variation amount corresponding to each of the touch areas according to the reference capacitance crosstalk value.

In an embodiment of the present invention, the crosstalk compensation unit corrects the capacitance variation amount corresponding to each of the touch areas according to a portion of the capacitance crosstalk values the liquid crystal pixels corresponding to each of the touch areas.

In an embodiment of the present invention, the crosstalk compensation unit calculate a sum of the portion of the capacitance crosstalk values of the liquid crystal pixels corresponding to each of the touch areas respectively multiplied by a corresponding weighted value to obtain a reference capacitance crosstalk value and corrects the capacitance variation amount corresponding to each of the touch areas according to the reference capacitance crosstalk value.

In an embodiment of the present invention, the touch display device further includes a crosstalk estimation unit receiving the display data to calculate the capacitance crosstalk value corresponding to each of the liquid crystal pixels according to a grayscale value of the display data corresponding to each of the liquid crystal pixels.

In an embodiment of the present invention, the crosstalk estimation unit further receives at least one of a vertical synchronization signal and a horizontal synchronization signal to determine the display data corresponding to each of the liquid crystal pixels according to the received at least one of the vertical synchronization signal and the horizontal synchronization signal.

In an embodiment of the present invention, the touch display device further includes a memory unit coupled to the crosstalk estimation unit and the crosstalk compensation unit and configured to receive and provide the capacitance crosstalk value corresponding to each of the liquid crystal pixels.

The present invention is directed to a method for sensing capacitance of a touch display device includes sensing a capacitance variation amount of each of a plurality of touch areas of a touch panel by using touch sensing circuit and correcting the capacitance variation amount corresponding to each of the touch areas according to a plurality of capacitance crosstalk values respectively corresponding to a plurality of liquid crystal pixels of the display panel by using a crosstalk compensation unit.

In an embodiment of the present invention, the step of correcting the capacitance variation amount corresponding to each of the touch areas according to the capacitance crosstalk values respectively corresponding to the liquid crystal pixels of the display panel by using the crosstalk compensation unit includes correcting the capacitance variation amount corresponding to each of the touch areas according to the capacitance crosstalk values of the liquid crystal pixels corresponding to each of the touch areas and the capacitance crosstalk values corresponding to the liquid crystal pixels neighboring with each of the touch areas by using the crosstalk compensation unit.

In an embodiment of the present invention, the step of correcting the capacitance variation amount corresponding to each of the touch areas according to the capacitance crosstalk values of the liquid crystal pixels corresponding to each of the touch areas and the capacitance crosstalk value of the liquid crystal pixels neighboring with each of the touch areas by using the crosstalk compensation unit includes calculating a sum of the capacitance crosstalk values of the liquid crystal pixels corresponding to each of the touch areas respectively multiplied by a corresponding weighted value and the capacitance crosstalk value of the liquid crystal pixels neighboring with each of the touch areas respectively multiplied by a corresponding weighted value by using the crosstalk compensation unit to obtain a reference capacitance crosstalk value and correcting the capacitance variation amount corresponding to each of the touch areas according to the reference capacitance crosstalk value.

In an embodiment of the present invention, the step of correcting the capacitance variation amount corresponding to each of the touch areas according to the capacitance crosstalk values respectively corresponding to the liquid crystal pixels of the display panel by using the crosstalk compensation unit includes correcting the capacitance variation amount corresponding to each of the touch areas according to the capacitance crosstalk values of the liquid crystal pixels corresponding to each of the touch areas by using the crosstalk compensation unit.

In an embodiment of the present invention, the step of correcting the capacitance variation amount corresponding to each of the touch areas according to the capacitance crosstalk values of the liquid crystal pixels corresponding to each of the touch areas by using the crosstalk compensation unit includes calculating a sum of the capacitance crosstalk values of the liquid crystal pixels corresponding to each of the touch areas respectively multiplied by a corresponding weighted value by using the crosstalk compensation unit to obtain a reference capacitance crosstalk value and correcting the capacitance variation amount corresponding to each of the touch areas according to the reference capacitance crosstalk value.

In an embodiment of the present invention, the step of correcting the capacitance variation amount corresponding to each of the touch areas according to the capacitance crosstalk values respectively corresponding to the liquid crystal pixels of the display panel by using the crosstalk compensation unit includes correcting the capacitance variation amount corresponding to each of the touch areas according to a portion of the capacitance crosstalk values of the liquid crystal pixels corresponding to each of the touch areas by using the crosstalk compensation unit.

In an embodiment of the present invention, the step of correcting the capacitance variation amount corresponding to each of the touch areas according to the portion of the capacitance crosstalk values of the liquid crystal pixels corresponding to each of the touch areas by using the crosstalk compensation unit includes calculating a sum of the portion of the capacitance crosstalk values the liquid crystal pixels corresponding to each of the touch areas respectively multiplied by a corresponding weighted value by using the crosstalk compensation unit to obtain a reference capacitance crosstalk value and correcting the capacitance variation amount corresponding to each of the touch areas according to the reference capacitance crosstalk value.

In an embodiment of the present invention, the method for sensing the capacitance of the touch display device further includes calculating the capacitance crosstalk value corresponding to each of the liquid crystal pixels by using a crosstalk estimation unit according to a grayscale value of display data corresponding to each of the liquid crystal pixels.

In an embodiment of the present invention, the weighted value corresponding to each of the liquid crystal pixels located in a center in each of the touch areas is greater than the weighted value corresponding to each of the liquid crystal pixels located at the outside of each of the touch areas, and the weighted value corresponding to each of the liquid crystal pixels located in the center in each of the touch areas is greater than the weighted value corresponding to the liquid crystal pixels located in a periphery of each of the touch areas.

According to above-mentioned, in the touch display device and the method for sensing the capacitance of the touch display device of the embodiments of the present invention, the capacitance variation amount corresponding to each of the touch areas of the touch panel is corrected according to the capacitance crosstalk values respectively corresponding to pixels of the display panel. Thereby, the affection caused by the capacitance variation of the liquid crystal of the liquid crystal pixels to the capacitance of the touch panel may be eliminated.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 a schematic diagram of a touch display device according to an embodiment of the present invention.

FIG. 2 is a corresponding schematic diagram between touch areas and pixels according to an embodiment of the present invention.

FIG. 3 is a corresponding schematic diagram between touch areas and pixels according to another embodiment of the present invention.

FIG. 4 is a corresponding schematic diagram between touch areas and pixels according to yet another embodiment of the present invention.

FIG. 5 is a corresponding schematic diagram between touch areas and weighted values of touch areas according to an embodiment of the present invention.

FIG. 6 is a flowchart of a method for sensing capacitance of a touch display device according to an embodiment of the present invention.

### DESCRIPTION OF EMBODIMENTS

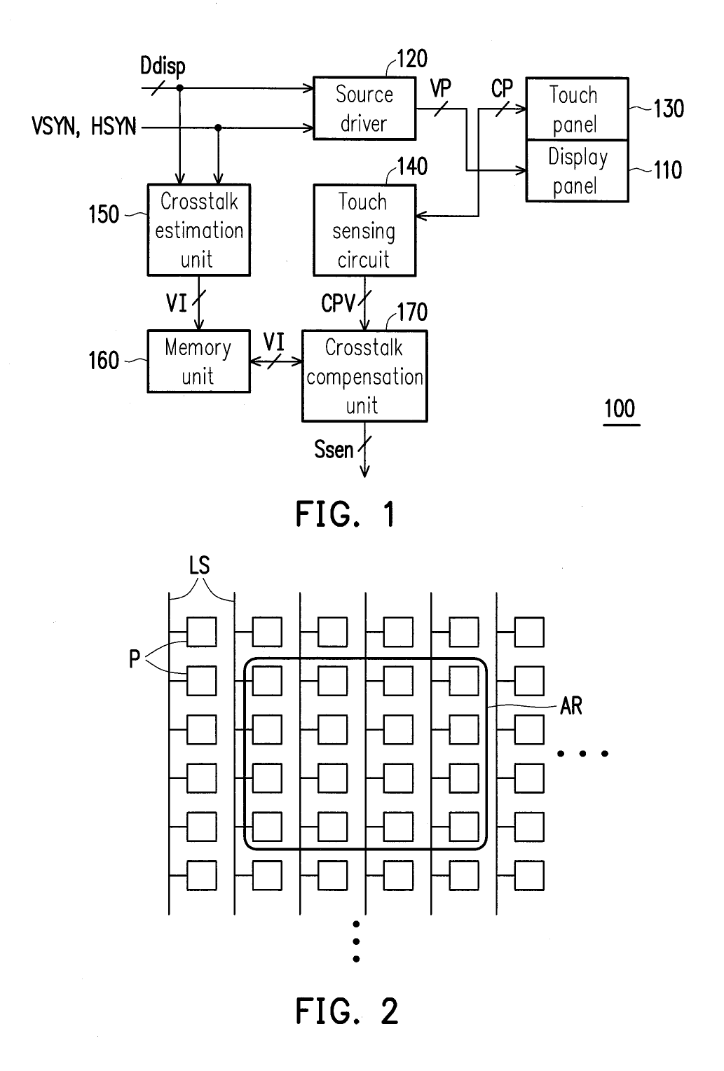

FIG. 1 a schematic diagram of a touch display device according to an embodiment of the present invention. FIG. 2 is a corresponding schematic diagram between touch areas and pixels according to an embodiment of the present invention. With reference to FIG. 1 and FIG. 2, in the present embodiment, a touch display device 100 includes a display panel 110, a source driver 120, a touch panel 130, a touch sensing circuit 140, a crosstalk estimation unit 150, a memory unit 160 and a crosstalk compensation unit 170. The display panel 110 and the touch panel 130 are adhered to each other; however, in other embodiments, the display panel 110 and the touch panel 130 may be integrated with each other, which is not limited in the embodiments of the present invention is not limited thereto.

The display panel 110 has a plurality of liquid crystal pixels P and a plurality of source lines SL. The source lines SL are configured to transmit corresponding pixel voltages VP. The source driver 120 is coupled to the display panel 110 and receives a plurality of display data Ddisp, a vertical synchronization signal VSYN and a horizontal synchronization signal HSYN to receive the display data Ddisp according to the vertical synchronization signal VSYN and the horizontal synchronization signal HSYN and to provide a plurality of pixel voltages VP according to the received display data Ddisp. The pixel voltages VP are correspondingly written into the liquid crystal pixels P.

The touch panel 130 is overlapped and disposed with the display panel 110. The touch panel 130 has a plurality of touch areas (e.g., an area AR). Due to the touch panel 130 being overlapped and disposed with the display panel 110, the touch areas (e.g., the touch area AR) of the touch panel 130 are overlapped with a portion of the liquid crystal pixels P, and namely, each of the touch areas (e.g., the touch area AR) is overlapped with (i.e., corresponding to) a portion of the liquid crystal pixels P. The touch panel 130 is, for example, a projected capacitive touch panel, but the embodiments of the present invention are not limited thereto. The touch sensing circuit 140 is coupled to the touch panel 130, senses capacitance variation CP of each touch area (e.g., the touch area AR) and outputs a plurality of capacitance variation amounts CPV.

The crosstalk estimation unit 150 receives the display data Ddisp, the vertical synchronization signal VSYN and the horizontal synchronization signal HSYN to receive the display data Ddisp according to the vertical synchronization signal VSYN and the horizontal synchronization signal HSYN and calculates (or determines) the display data Ddisp corresponding to each of the liquid crystal pixels P according to the vertical synchronization signal VSYN and/or the horizontal synchronization signal HSYN. Then, the crosstalk estimation unit 150 calculates an equivalent capacitance of each of the liquid crystal pixels P (i.e., a capacitance crosstalk value VI corresponding to each of the liquid crystal pixels P) according to a grayscale value (e.g. grayscale values 0-255) represented by the display data Ddisp corresponding to each of the liquid crystal pixels P. In different liquid crystal structures, the equivalent capacitance of each of the liquid crystal pixels P may be different and after writing different pixel voltages VP, the equivalent capacitance of each of the liquid crystal pixels P may be changed due to the influence of the rotation of liquid crystals. The aforementioned change may be an increase with the increase of the grayscale values, or a decrease with the increase of the grayscale values, depending on the actual circuit, which constructs no limitations to the embodiments of the present invention.

The memory unit 160 is coupled to the crosstalk estimation unit 150 and configured to store and provide the capacitance crosstalk value VI corresponding to each of the liquid crystal pixels P. The memory unit 160 may formed by buffers or memories to store the capacitance crosstalk value VI corresponding to each of the liquid crystal pixels P. In other words, each buffer may store a corresponding capacitance crosstalk value VI, or alternatively, a memory address corresponding to each of the liquid crystal pixels P may be used to store a corresponding capacitance crosstalk value VI.

The crosstalk compensation unit 170 is coupled to the touch sensing circuit 140 to receive the capacitance variation amounts of the touch areas, and coupled to the memory unit 160 to receive the capacitance crosstalk value VI corresponding to each of the liquid crystal pixels P. The crosstalk compensation unit 170 calculates a capacitance variation of each touch area (e.g., the touch area AR) due to the influence of each of the liquid crystal pixels P (i.e. a reference capacitance crosstalk value) according to the capacitance crosstalk value VI corresponding to each of the liquid crystal pixels P and provides a plurality of sensing signals Ssen after correcting the capacitance variation amount CPV corresponding to each of the touch areas (e.g., the touch area AR) according to reference capacitance crosstalk value of each of the touch areas (e.g., the touch area AR). In different embodiments, the way to correct the capacitance variation amount CPV may be different. In other words, the reference capacitance crosstalk value may be added to the capacitance variation amount CPV, subtracted from the capacitance variation amount CPV, multiplied with the capacitance variation amount CPV, or the capacitance variation amount CPV may be divided by the reference capacitance crosstalk value, but the present invention is not limited thereto.

Moreover, referring to FIG. 2, the touch area AR is overlapped with a portion of the liquid crystal pixels P (i.e., the touch area AR corresponds to a portion of the liquid crystal pixels P). In an embodiment of the present invention, the crosstalk compensation unit 150 may calculate the reference capacitance crosstalk value according to according to the capacitance crosstalk value VI of the liquid crystal pixels P corresponding to (i.e., overlapped with) the touch area AR. That is, the crosstalk compensation unit 150 may calculate the reference capacitance crosstalk value according to the capacitance crosstalk value VI of the liquid crystal pixels P located in the touch area AR so as to correct the capacitance variation amount CPV corresponding to the touch area AR according to the reference capacitance crosstalk value.

Besides, the liquid crystal pixels P located in different positions in the touch area AR may cause different effects on the capacitance variation amount CPV of the touch area AR, and thus, a weighted value may be correspondingly set for each of the liquid crystal pixels P located in the touch area AR. Then, the crosstalk compensation unit 150 may calculate a sum of the capacitance crosstalk values VI corresponding to the liquid crystal pixels P corresponding to the touch area AR respectively multiplied by the corresponding weighted value to obtain the reference capacitance crosstalk value, and correct the capacitance variation amount CPV corresponding to the touch area AR according to the reference capacitance crosstalk value, which may calculate based on an equation as below:

$$Crosstalk ( i , j ) = {α}_{i , j} \cdot {\sum }_{D ( m , n ) ∈ T ( i , j )}^{ } ( {w}_{m , n} \cdot D ( m , n ) )$$

Wherein, D(m,n) is a grayscale value represented by display data Ddisp corresponding to a liquid crystal pixel P having a coordinate (m,n), w_{m,n} is a weighted value corresponding to the liquid crystal pixel P located in the coordinate (m,n), α_{i,j} is a crosstalk weighted value (i.e., a relationship between the grayscale value and the capacitance crosstalk value VI) corresponding to a touch area T_{i,j} (e.g., the touch area AR) located in a coordinate (i,j), and a crosstalk (i,j) is a reference capacitance crosstalk value corresponding to the touch area (e.g., the touch area AR) located in the coordinate (i,j). Thereby, a distance from each of the liquid crystal pixels P to a center point (which may be considered as a touch node) of the touch area (e.g., the touch area AR) may be compensated, or a crosstalk effect of each of the liquid crystal pixels P on the touch area (e.g., the touch area AR) may be compensated. The reference capacitance crosstalk value is calculated by using a weighted sum method, but the present invention is not limited thereto, and a general sum operation may be performed by omitting the parameter w_{m,n}.

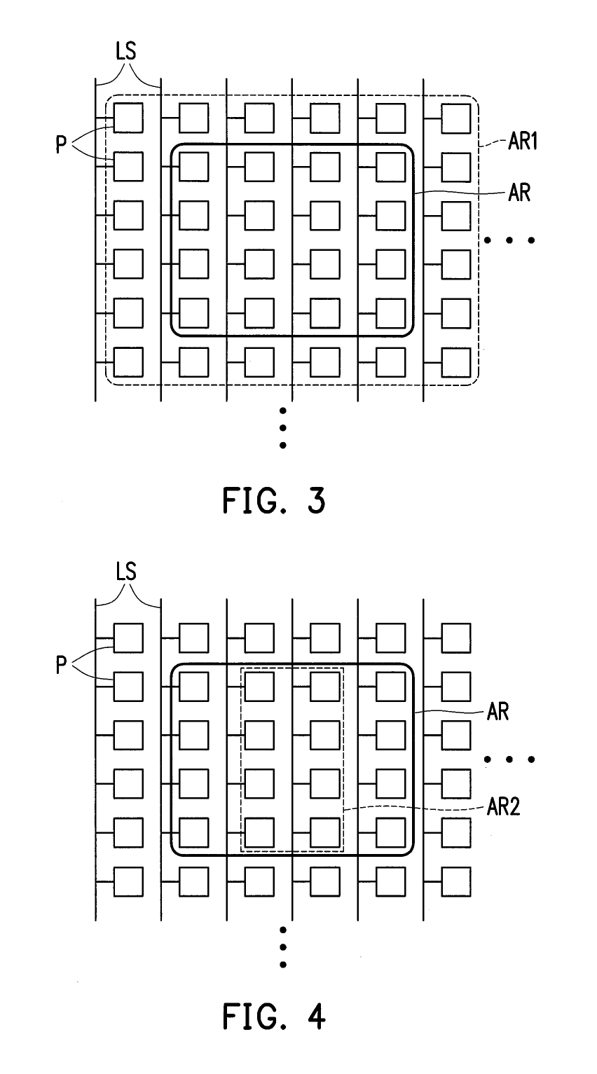

FIG. 3 is a corresponding schematic diagram between touch areas and pixels according to another embodiment of the present invention. With reference to FIG. 1 through FIG. 3, the same or similar elements are denoted by the same or similar symbols. In the present embodiment, the crosstalk compensation unit 150 may calculate the reference capacitance crosstalk value according to the capacitance crosstalk values VI of the liquid crystal pixels P corresponding to the touch area AR and the capacitance crosstalk values VI of liquid crystal pixels P neighboring with the touch area AR, i.e., the capacitance crosstalk values VI of the liquid crystal pixels P located within an area AR1, so as to correct the capacitance variation amount CPV corresponding to the touch area AR according to the reference capacitance crosstalk value.

Similarly, in the present embodiment, since the liquid crystal pixels P located in the different positions in the touch area AR may cause different effects on the capacitance variation amount CPV of the touch area AR, a weighted value may be correspondingly set for each of the liquid crystal pixels P located in the touch area AR. Then, the crosstalk compensation unit 150 calculates a sum of the capacitance crosstalk values VI of the liquid crystal pixels P corresponding to the touch area AR respectively multiplied by the corresponding weighted value and the capacitance crosstalk value VI of the liquid crystal pixels P neighboring with the touch area AR respectively multiplied by the corresponding weighted value to obtain the reference capacitance crosstalk value, and correct the capacitance variation amount CPV corresponding to the touch area AR according to the reference capacitance crosstalk value.

FIG. 4 is a corresponding schematic diagram between touch areas and pixels according to yet another embodiment of the present invention. With reference to FIG. 1, FIG. 2 and FIG. 4, the same or similar elements are denoted by the same or similar symbols. In the present embodiment, the crosstalk compensation unit 150 calculates a reference capacitance crosstalk value according to a portion of the capacitance crosstalk values VI of the liquid crystal pixels P corresponding to the touch area AR. For instance, the crosstalk compensation unit 150 calculates the reference capacitance crosstalk value according to a plurality of capacitance crosstalk values VI corresponding to the liquid crystal pixels P located in an area AR2 so as to calculate a capacitance variation amount CPV corresponding to the touch area AR according to the reference capacitance crosstalk value.

Similarly, in the present embodiment, in the present embodiment, since the liquid crystal pixels P located in the different positions in the touch area AR may cause different effects on the capacitance variation amount CPV of the touch area AR, a weighted value may be correspondingly set for each of the liquid crystal pixels P located in the touch area AR. Then, the crosstalk compensation unit 150 calculates a sum of the capacitance crosstalk values VI of the liquid crystal pixels P corresponding to the area AR2 respectively multiplied by the corresponding weighted value to obtain the reference capacitance crosstalk value, and correct the capacitance variation amount CPV corresponding to the touch area AR according to the reference capacitance crosstalk value.

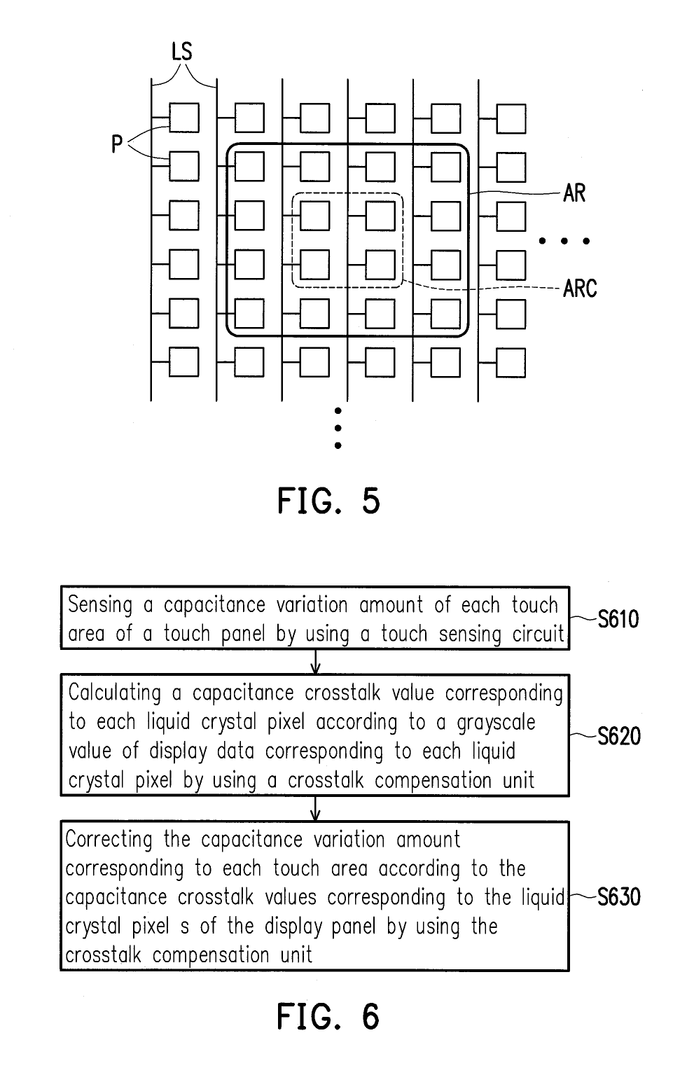

FIG. 5 is a corresponding schematic diagram between touch areas and weighted values of touch areas according to an embodiment of the present invention. With reference to FIG. 2 and FIG. 5 the same or similar elements are denoted by the same or similar symbols. In the present embodiment, it is assumed that the weighted value corresponding to each of the liquid crystal pixels P is inversely proportional to the distance from each of the liquid crystal pixels P to the center point of the touch area A. In other words, the weighted value corresponding to each of the liquid crystal pixels P located in the touch area AR is greater than a weighted value corresponding to each of the liquid crystal pixels P located at the outside of the touch area AR, and a weighted value corresponding to each of the liquid crystal pixels P in the center of the touch area AR (e.g., in an area ARC) is greater than a weighted value corresponding to each of the liquid crystal pixels P locate in the periphery of the touch area AR (e.g., in the touch area AR, but out of the area ARC), which are all illustrated for example, but do not construct any limitations to the present invention.

Additionally, it is assumed that a ratio of a screen display frequency to a touch scan frequency is 1:1 in the present embodiment. When the ratio of the screen display frequency to the touch scan frequency is 2:1, that is, the display panel 110 displays two image frames in a time for the touch panel 130 to perform scanning once, the crosstalk compensation unit 150 obtains two reference capacitance crosstalk values corresponding to each of the touch areas (e.g., the touch area AR), and the crosstalk compensation unit 150 corrects the capacitance variation amount CPV corresponding to the touch area AR according to the two reference capacitance crosstalk values (e.g., obtained by calculating a mean thereof, or by the weighted sum operation) of each of touch areas (e.g., the touch area AR). Likewise, the crosstalk compensation unit 150 may correct the capacitance variation amount CP according to reference capacitance crosstalk values of other numbers that are calculated according to other different ratios of the screen display frequency to the touch scan frequency, which will not be repeatedly described hereinafter.

Besides, the liquid crystal pixels P selected for calculating the reference capacitance crosstalk value are examples for illustration, and persons having ordinary skill in the art may set the selected liquid crystal pixels P according to their own demand for circuit design. Meanwhile, weighted value may be set by the persons having ordinary skill in the art may set, which should not be construed as a limitation to the present invention.

FIG. 6 is a flowchart of a method for sensing capacitance of a touch display device according to an embodiment of the present invention. With reference to FIG. 6, in the present embodiment, a method for sensing capacitance of a touch display device includes steps as follows. In step S610, a capacitance variation amount of each of a plurality of touch areas of a touch panel is sensed by using touch sensing circuit. In step S620, a capacitance crosstalk value corresponding to each of liquid crystal pixels is calculated according to a grayscale value of display data corresponding to each of the liquid crystal pixels by using a crosstalk estimation unit. In step S630, the capacitance variation amount corresponding to each of the touch areas is corrected according to the capacitance crosstalk values respectively corresponding to the liquid crystal pixels of the display panel by using the crosstalk compensation unit. Therein, the sequence of steps S610, S620 and S630 is illustrated for example, and does not construct any limitations to the present invention. In the meantime, details of steps S610, S620 and S630 may refer to the embodiments illustrated in FIG. 1 through FIG. 5, and will not be repeatedly described hereinafter.

To sum up, in the touch display device and the method for sensing the capacitance of the touch display device of the embodiments of the present invention, the capacitance variation amount corresponding to each of the touch areas of the touch panel is corrected according to the capacitance crosstalk values respectively corresponding to pixels of the display panel. Thereby, the affection caused by the capacitance variation of the liquid crystal of the liquid crystal pixels to the capacitance of the touch panel may be eliminated.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display device, comprising:
a display panel, having a plurality of liquid crystal pixels;
a source driver, coupled to the display panel and receiving a plurality of display data to write a plurality of pixel voltages to the liquid crystal pixels according to the display data;
a touch panel, disposed and overlapped with the display panel and having a plurality of touch areas, wherein each of the touch areas corresponding to a portion of the liquid crystal pixels;
a touch sensing circuit, coupled to the touch panel and sensing a capacitance variation amount corresponding to each of the touch areas;
a crosstalk compensation unit, coupled to the touch sensing circuit, receiving the capacitance variation amount corresponding to each of the touch areas and correcting the capacitance variation amount corresponding to each of the touch areas according to a plurality of capacitance crosstalk values respectively corresponding to the liquid crystal pixels so as to provide a plurality sensing signals.

2. The touch display device according to claim 1, wherein the crosstalk compensation unit corrects the capacitance variation amount corresponding to each of the touch areas according to the capacitance crosstalk values of the liquid crystal pixels corresponding to each of the touch areas and the capacitance crosstalk values of liquid crystal pixels neighboring with each of the touch areas.

3. The touch display device according to claim 2, wherein the crosstalk compensation unit calculate a sum of the capacitance crosstalk values of the liquid crystal pixels corresponding to each of the touch areas respectively multiplied by a corresponding weighted value and the capacitance crosstalk values of the liquid crystal pixels neighboring with each of the touch areas respectively multiplied by a corresponding weighted value to obtain a reference capacitance crosstalk value and corrects the capacitance variation amount corresponding to each of the touch areas according to the reference capacitance crosstalk value.

4. The touch display device according to claim 3, wherein the weighted value corresponding to each of the liquid crystal pixels located in a center in each of the touch areas is greater than the weighted value corresponding to each of the liquid crystal pixels located at the outside of each of the touch areas.

5. The touch display device according to claim 1, wherein the crosstalk compensation unit corrects the capacitance variation amount corresponding to each of the touch areas according to the capacitance crosstalk values of the liquid crystal pixels corresponding to each of the touch areas.

6. The touch display device according to claim 5, wherein the crosstalk compensation unit calculates a sum of the capacitance crosstalk values of the liquid crystal pixels corresponding to each of the touch areas respectively multiplied by a corresponding weighted value to obtain a reference capacitance crosstalk value and corrects the capacitance variation amount corresponding to each of the touch areas according to the reference capacitance crosstalk value.

7. The touch display device according to claim 6, wherein the weighted value corresponding to each of the liquid crystal pixels located in a center in each of the touch areas is greater than the weighted value corresponding to each of the liquid crystal pixels located in a periphery of each of the touch areas.

8. The touch display device according to claim 1, wherein the crosstalk compensation unit corrects the capacitance variation amount corresponding to each of the touch areas according to a portion of the capacitance crosstalk values of the liquid crystal pixels corresponding to each of the touch areas.

9. The touch display device according to claim 8, wherein the crosstalk compensation unit calculate a sum of the portion of the capacitance crosstalk value of the liquid crystal pixels corresponding to each of the touch areas respectively multiplied by a corresponding weighted value to obtain a reference capacitance crosstalk value and corrects the capacitance variation amount corresponding to each of the touch areas according to the reference capacitance crosstalk value.

10. The touch display device according to claim 9, wherein the weighted value corresponding to each of the liquid crystal pixels located in a center in each of the touch areas is greater than the weighted value corresponding to each of the liquid crystal pixels located in a periphery of each of the touch areas.

11. The touch display device according to claim 1, further comprising:
a crosstalk estimation unit, receiving the display data to calculate the capacitance crosstalk value corresponding to each of the liquid crystal pixels according to a grayscale value of the display data corresponding to each of the liquid crystal pixels.

12. The touch display device according to claim 11, wherein the crosstalk estimation unit further receives at least one of a vertical synchronization signal and a horizontal synchronization signal to determine the display data corresponding to each of the liquid crystal pixels according to the received at least one of the vertical synchronization signal and the horizontal synchronization signal.

13. The touch display device according to claim 11, further comprising:
a memory unit, coupled to the crosstalk estimation unit and the crosstalk compensation unit and configured to receive and provide the capacitance crosstalk value corresponding to each of the liquid crystal pixels.

14. A method for sensing capacitance of a touch display device, comprising:
sensing a capacitance variation amount of each of a plurality of touch areas of a touch panel by using a touch sensing circuit; and
correcting the capacitance variation amount corresponding to each of the touch areas touch areas according to a plurality of capacitance crosstalk values respectively corresponding to a plurality of liquid crystal pixels of the display panel by using a crosstalk compensation unit.

15. The method according to claim 14, wherein the step of correcting the capacitance variation amount corresponding to each of the touch areas according to the capacitance crosstalk values respectively corresponding to the liquid crystal pixels of the display panel by using the crosstalk compensation unit comprises:
correcting the capacitance variation amount corresponding to each of the touch areas according to the capacitance crosstalk values of the liquid crystal pixels corresponding to each of the touch areas and the capacitance crosstalk values corresponding to the liquid crystal pixels neighboring with each of the touch areas by using the crosstalk compensation unit.

16. The method according to claim 15, wherein the step of correcting the capacitance according to the capacitance crosstalk values of the liquid crystal pixels corresponding to each of the touch areas and the capacitance crosstalk values of the liquid crystal pixels neighboring with each of the touch areas by using the crosstalk compensation unit comprises:
calculating a sum of the capacitance crosstalk values of the liquid crystal pixels corresponding to each of the touch areas respectively multiplied by a corresponding weighted value and the capacitance crosstalk values of the liquid crystal pixels neighboring with each of the touch areas respectively multiplied by a corresponding weighted value by using the crosstalk compensation unit to obtain a reference capacitance crosstalk value and correcting the capacitance variation amount corresponding to each of the touch areas according to the reference capacitance crosstalk value.

17. The method according to claim 16, wherein the weighted value corresponding to each of the liquid crystal pixels located in a center in each of the touch areas is greater than the weighted value corresponding to each of the liquid crystal pixels located at the outside of each of the touch areas.

18. The method according to claim 14, wherein the step of correcting the capacitance variation amount corresponding to each of the touch areas according to the capacitance crosstalk values corresponding to the liquid crystal pixels of the display panel by using the crosstalk compensation unit comprises:
correcting the capacitance variation amount corresponding to each of the touch areas according to the capacitance crosstalk values of the liquid crystal pixels corresponding to each of the touch areas by using the crosstalk compensation unit.

19. The method according to claim 18, wherein the step of correcting the capacitance variation amount corresponding to each of the touch areas according to the capacitance crosstalk values of the liquid crystal pixels corresponding to each of the touch areas by using the crosstalk compensation unit comprises:
calculating a sum of the capacitance crosstalk values of the liquid crystal pixels corresponding to each of the touch areas respectively multiplied by a corresponding weighted value by using the crosstalk compensation unit to obtain a reference capacitance crosstalk value and correcting the capacitance variation amount corresponding to each of the touch areas according to the reference capacitance crosstalk value.

20. The method according to claim 19, wherein the weighted value corresponding to each of the liquid crystal pixels located in a center in each of the touch areas is greater than the weighted value corresponding to each of the liquid crystal pixels located in a periphery of each of the touch areas.

21. The method according to claim 14, wherein the step of correcting the capacitance variation amount corresponding to each of the touch areas according to the capacitance crosstalk values corresponding to the liquid crystal pixels of the display panel by using the crosstalk compensation unit comprises:
correcting the capacitance variation amount corresponding to each of the touch areas according to a portion of the capacitance crosstalk values of the liquid crystal pixels corresponding to each of the touch areas by using the crosstalk compensation unit.

22. The method according to claim 21, wherein the step of correcting the capacitance variation amount corresponding to each of the touch areas according to the portion of the capacitance crosstalk value of the liquid crystal pixels corresponding to each of the touch areas by using the crosstalk compensation unit comprises:
calculating a sum of the portion of the capacitance crosstalk value of the liquid crystal pixels corresponding to each of the touch areas respectively multiplied by a corresponding weighted value by using the crosstalk compensation unit to obtain a reference capacitance crosstalk value and correcting the capacitance variation amount corresponding to each of the touch areas according to the reference capacitance crosstalk value.

23. The method according to claim 22, wherein the weighted value corresponding to each of the liquid crystal pixels located in a center in each of the touch areas is greater than the weighted value corresponding to each of the liquid crystal pixels located in a periphery of each of the touch areas.

24. The method according to claim 14, further comprising:
calculating the capacitance crosstalk value corresponding to each of the liquid crystal pixels according to a grayscale value of display data corresponding to each of the liquid crystal pixels by using a crosstalk estimation unit.
